(19) United States
(12) Patent Application Publication
(10) Pub. No.: US 2026/0095513 A1
(43) Pub. Date: Apr. 2, 2026

(54) METHOD AND SYSTEM FOR REROUTING AN INTERNATIONAL STANDARD-BASED RESOURCE TRANSMISSION REQUEST

(71) Applicant: JPMorgan Chase Bank, N.A., New York, NY (US)

(72) Inventors: Chagla M SALEH-ESA, Rego Park, NY (US); Vadim TSUKHTMAN, Bronx, NY (US); Mark K SUJEEBUN, Columbus, OH (US); Johnicholas HINES, Wilmington, DE (US); Christine RAY, West Chester, PA (US); Sreeja P PUROHIT, Mumbai (IN); Michael J. Catchpole, Montclair, NJ (US); Gary Radchik, Fair Lawn, NJ (US)

(73) Assignee: JPMorgan Chase Bank, N.A., New York, NY (US)

(21) Appl. No.: 18/953,552

(22) Filed: Nov. 20, 2024

(30) Foreign Application Priority Data
Sep. 30, 2024 (IN) 202411073887

(51) Int. Cl. H04L 67/60

(52) U.S. Cl. CPC H04L 67/60

(57) ABSTRACT

A system is provided for implementing an international standard-based resource transmission request rerouting tool. The system may perform operations that comprise: receiving a first set of resource transmission requests that are associated with the resource transmission network; redirecting, away from a legacy processing platform of the resource transmission network, the first set of resource transmission requests to a resource transmission request routing engine; performing, by the resource transmission request routing engine, a preliminary analysis by evaluating each resource transmission request against at least one from among a first set of rules and a first set of filters; based on the preliminary analysis, forwarding, by the resource transmission request routing engine, the resource transmission request to an corresponding processing platform; and processing, by the corresponding processing platform, the resource transmission request.

### CROSS-REFERENCE TO RELATED APPLICATIONS

This application claims priority benefit from Indian Application No. 202411073887, filed Sep. 30, 2024, which is hereby incorporated by reference in its entirety.

### BACKGROUND

### 1. Field

This disclosure generally relates to rerouting resource transmission requests and, more particularly, to a method, system, and computer-readable medium for implementing an international standard-based resource transmission request rerouting tool that reroutes resource transmission requests to optimize and, thereby, improve processing efficiency.

### 2. Background

Today's electronic transmission networks enable users to receive a plethora of resources and services remotely via one or more electronic transmissions. To this end, enterprises have put various hardware and software infrastructures in place that provide the underlying technology required to transmit such resources and services to users.

Unfortunately, with the advent of the information age's perpetual onslaught of new technology, keeping an electronic transmission network's design, maintenance and security up to date with the state of the art has now become a near impossible task for the engineers of such networks to perform on their own.

Accordingly, various tools have been developed to provide today's network engineers with new approaches to electronic transmission network engineering. However, there is still a need to keep such networks as up to date as possible.

The subject disclosure presents a solution that improves existing technology by providing new functionalities and by aggregating functionalities into a single system.

### SUMMARY

The present disclosure, through one or more of its various aspects, embodiments, and/or specific features or sub-component, provides, inter alia, various systems, servers, devices, methods, media, programs and platforms for rerouting resource transmission requests to optimize and, thereby, improve their processing efficiency.

According to an aspect of the present disclosure, a method is provided for implementing a resource transmission request rerouting tool, the method comprising: receiving, at a resource transmission network of an enterprise, a first set of resource transmission requests that are associated with the resource transmission network; redirecting, away from a legacy processing platform of the resource transmission network, the first set of resource transmission requests to a resource transmission request routing engine; performing, by the resource transmission request routing engine, a preliminary analysis by evaluating each resource transmission request against at least one from among a first set of rules and a first set of filters; based on the preliminary analysis, forwarding, by the resource transmission request routing engine, the resource transmission request to a corresponding processing platform that is configured to process the resource transmission request; and processing, by the corresponding processing platform, the resource transmission request.

In the method, the corresponding processing platform may comprise at least one from among a new processing platform of the resource transmission network, a heightened-scrutiny processing platform, a dummy processing platform, the legacy processing platform, and a commercial resource transmission request processing platform from an external vendor.

In the method, the at least one from among the first set of rules and the first set of filters may evaluate a first set of fields of the resource transmission request, and the resource transmission request may comprise a standard resource transmission request format that includes the first set of fields.

In the method, the first set of fields may comprise at least one from among a message length field, a message header field, message type field, at least a primary bitmap field, and a data elements field, and the at least the primary bitmap field may comprise at least one from among the primary bitmap field, a secondary bitmap field, and a tertiary bitmap field.

In the method, the preliminary analysis may comprise determining whether the first set of resource transmission requests includes at least one from among an anomalous traffic pattern and a suspicious traffic pattern.

In the method, the preliminary analysis may comprise determining at least one from among a resource transmission request type and a resource transmission request source.

In the method, the at least one from among the first set of rules and the first set of filters may comprise at least one from among a load balancing rule, a load balancing filter, a traffic migration rule, a traffic migration filter, a traffic blocking rule, a traffic blocking filter, a traffic volume rule, and a traffic volume filter. At least one from among the traffic blocking rule and the traffic blocking filter may comprise at least one from among a denial-of-service attack blocking rule and a denial-of-service attack blocking filter, and at least one from among the traffic volume rule and the traffic volume filter may comprise at least one from among a traffic volume limiting rule and a traffic volume limiting filter.

In the method, the at least one from among the first set of rules and the first set of filters may comprise at least one from among a processing platform threshold resource transmission amount and a processing platform threshold response time.

In the method, wherein the processing comprises: generating, by the corresponding processing platform, a reply to the resource transmission request; and transmitting, via the resource transmission network, the reply to a requesting device of the resource transmission request.

In the method, the reply may comprise at least one from among an authorization of the resource transmission request and a denial of the resource transmission request.

According to another aspect of the present disclosure, a system is provided for implementing a resource transmission request rerouting tool. The system may comprise a processor, and memory that stores instructions. When executed by the processor, the instructions may cause the processor to perform operations. The operations may comprise: receiving, at a resource transmission network of an enterprise, a first set of resource transmission requests that are associated with the resource transmission network; redirecting, away from a legacy processing platform of the resource transmission network, the first set of resource transmission requests to a resource transmission request routing engine; performing, by the resource transmission request routing engine, a preliminary analysis by evaluating each resource transmission request against at least one from among a first set of rules and a first set of filters; based on the preliminary analysis, forwarding, by the resource transmission request routing engine, the resource transmission request to a corresponding processing platform that is configured to process the resource transmission request; and processing, by the corresponding processing platform, the resource transmission request.

In the system, when the instructions are executed by the processor, the corresponding processing platform may comprises at least one from among a new processing platform of the resource transmission network, a heightened-scrutiny processing platform, a dummy processing platform, the legacy processing platform, and a commercial resource transmission request processing platform from an external vendor.

In the system, when the instructions are executed by the processor, the at least one from among the first set of rules and the first set of filters may evaluate a first set of fields of the resource transmission request. The resource transmission request may comprises a standard resource transmission request format that includes the first set of fields.

In the system, when the instructions are executed by the processor, the first set of fields may comprise at least one from among a message length field, a message header field, message type field, at least a primary bitmap field, and a data elements field. The at least the primary bitmap field may comprise at least one from among the primary bitmap field, a secondary bitmap field, and a tertiary bitmap field.

In the system, when the instructions are executed by the processor, the preliminary analysis may comprise determining whether the first set of resource transmission requests includes at least one from among an anomalous traffic pattern and a suspicious traffic pattern.

In the system, when the instructions are executed by the processor, the preliminary analysis may comprise determining at least one from among a resource transmission request type and a resource transmission request source.

In the system, wherein when the instructions are executed by the processor, the at least one from among the first set of rules and the first set of filters may comprise at least one from among a load balancing rule, a load balancing filter, a traffic migration rule, a traffic migration filter, a traffic blocking rule, a traffic blocking filter, a traffic volume rule, and a traffic volume filter. At least one from among the traffic blocking rule and the traffic blocking filter may comprise at least one from among a denial-of-service attack blocking rule and a denial-of-service attack blocking filter, and at least one from among the traffic volume rule and the traffic volume filter may comprise at least one from among a traffic volume limiting rule and a traffic volume limiting filter.

In the system, when the instructions are executed by the processor, the at least one from among the first set of rules and the first set of filters may comprise at least one from among a processing platform threshold resource transmission amount and a processing platform threshold response time.

In the system, when the instructions are executed by the processor, the processing may comprise: generating, by the corresponding processing platform, a reply to the resource transmission request; and transmitting, via the resource transmission network, the reply to a requesting device of the resource transmission request.

In the system, when the instructions are executed by the processor, the reply may comprise at least one from among an authorization of the resource transmission request and a denial of the resource transmission request.

According to yet another aspect of the present disclosure, a non-transitory computer-readable medium is provided for implementing a resource transmission request rerouting tool. The computer-readable medium may store instructions. When executed by a processor, the instructions may cause the processor to perform operations. The operations may comprises: receiving, at a resource transmission network of an enterprise, a first set of resource transmission requests that are associated with the resource transmission network; redirecting, away from a legacy processing platform of the resource transmission network, the first set of resource transmission requests to a resource transmission request routing engine; performing, by the resource transmission request routing engine, a preliminary analysis by evaluating each resource transmission request against at least one from among a first set of rules and a first set of filters; based on the preliminary analysis, forwarding, by the resource transmission request routing engine, the resource transmission request to a corresponding processing platform that is configured to process the resource transmission request; and processing, by the corresponding processing platform, the resource transmission request.

In the computer-readable medium, when the instructions are executed by the processor, the corresponding processing platform may comprise at least one from among a new processing platform of the resource transmission network, a heightened-scrutiny processing platform, a dummy processing platform, the legacy processing platform, and a commercial resource transmission request processing platform from an external vendor.

In the computer-readable medium, when the instructions are executed by the processor, the at least one from among the first set of rules and the first set of filters may evaluate a first set of fields of the resource transmission request. The resource transmission request may comprise a standard resource transmission request format that includes the first set of fields.

In the computer-readable medium, when the instructions are executed by the processor, the first set of fields may comprise at least one from among a message length field, a message header field, message type field, at least a primary bitmap field, and a data elements field. The at least the primary bitmap field may comprise at least one from among the primary bitmap field, a secondary bitmap field, and a tertiary bitmap field.

In the computer-readable medium, when the instructions are executed by the processor, the preliminary analysis may comprise determining whether the first set of resource transmission requests includes at least one from among an anomalous traffic pattern and a suspicious traffic pattern.

In the computer-readable medium, when the instructions are executed by the processor, the preliminary analysis may comprise determining at least one from among a resource transmission request type and a resource transmission request source.

In the computer-readable medium, wherein when the instructions are executed by the processor, the at least one from among the first set of rules and the first set of filters may comprise at least one from among a load balancing rule, a load balancing filter, a traffic migration rule, a traffic migration filter, a traffic blocking rule, a traffic blocking filter, a traffic volume rule, and a traffic volume filter. At least one from among the traffic blocking rule and the traffic blocking filter may comprise at least one from among a denial-of-service attack blocking rule and a denial-of-service attack blocking filter, and at least one from among the traffic volume rule and the traffic volume filter may comprise at least one from among a traffic volume limiting rule and a traffic volume limiting filter.

In the computer-readable medium, when the instructions are executed by the processor, the at least one from among the first set of rules and the first set of filters may comprise at least one from among a processing platform threshold resource transmission amount and a processing platform threshold response time.

In the computer-readable medium, when the instructions are executed by the processor, the processing may comprise: generating, by the corresponding processing platform, a reply to the resource transmission request; and transmitting, via the resource transmission network, the reply to a requesting device of the resource transmission request.

In the computer-readable medium, when the instructions are executed by the processor, the reply may comprise at least one from among an authorization of the resource transmission request and a denial of the resource transmission request.

Accordingly, the invention disclosed herein provides a novel approach to implementing a resource transmission request rerouting tool that optimizes and, thereby, improves its resource transmission requests'processing efficiency.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of a computer system, according to an embodiment.

FIG. 2 depicts a diagram of an environment for implementing a resource transmission request rerouting tool, according to an embodiment.

FIG. 3 depicts a diagram of a perspective of an environment that is configured to implement a resource transmission request rerouting tool, according to an embodiment.

FIG. 4 depicts a flowchart of a process for implementing a resource transmission request rerouting tool, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

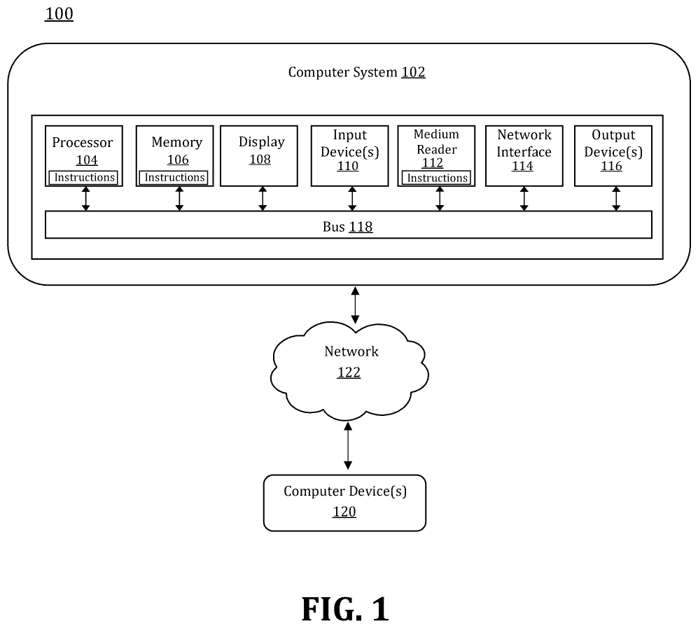

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an international standard-based resource transmission request rerouting tool that optimizes and, thereby, improves its resource transmission requests'processing efficiency.

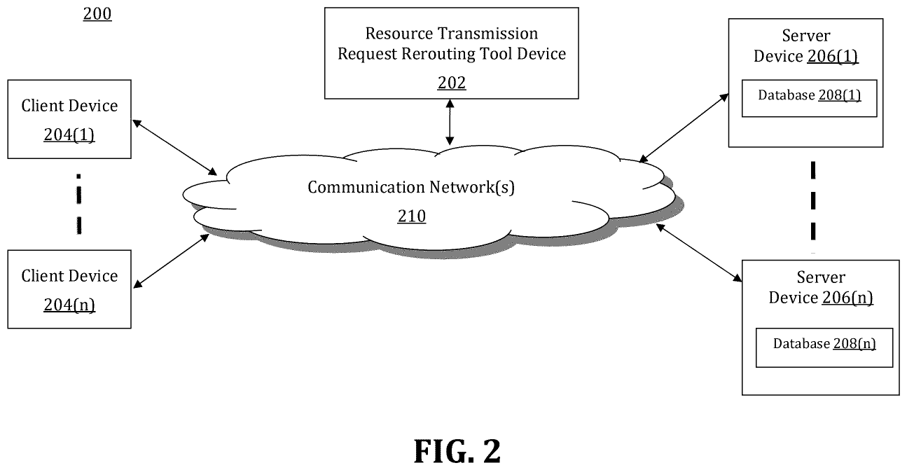

Referring to FIG. 2, a schematic of a network environment 200 for implementing a resource transmission request rerouting tool. In an embodiment, the international standard-based resource transmission request rerouting tool may be implemented on any networked computer platform, such as, for example, a personal computer (PC).

A method for rerouting a resource transmission request, may be implemented by a resource transmission request rerouting tool (RTRRT) device 202. The RTRRT device 202 may be the same or similar to the computer system 102 as described with respect to FIG. 1. The RTRRT device 202 may be a rack-mounted server in a datacenter, an embedded microcontroller (MCU) in an electronic device, or another type of headless system, which is a computer system or device that is configured to operate without a monitor, keyboard and mouse. The RTRRT device 202 may store one or more applications that can include executable instructions that, when executed by the RTRRT device 202, cause the RTRRT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RTRRT device 202 itself, may be located in virtual server(s) running in a cloud-based computing environment rather than being tied to one or more specific physical network computing devices. Also, the application(s) may be running in one or more virtual machines (VMs) executing on the RTRRT device 202. Additionally, in one or more embodiments of this technology, virtual machine(s) running on the RTRRT device 202 may be managed or supervised by a hypervisor.

In the network environment 200 of FIG. 2, the RTRRT device 202 is coupled to a plurality of client devices 204(1)-204(n), and also to a plurality of server devices 206(1)-206(n) that hosts a plurality of databases 208(1)-208(n) via communication network(s) 210. A communication interface of the RTRRT device 202, such as the network interface 114 of the computer system 102 of FIG. 1, operatively couples and communicates between the RTRRT device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RTRRT device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and RTRRT devices that implement a method for a resource transmission request rerouting tool that reroutes to optimize and, thereby, improve its resource transmission requests'processing efficiency.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical”and/or “virtual”locale.

The RTRRT device 202 may be a standalone device or integrated with one or more other devices or apparatuses, such as one or more of the server devices 206(1)-206(n), for example. In one particular example, the RTRRT device 202 may include or be hosted by one of the server devices 206(1)-206(n), and other arrangements are also possible. As another example, the RTRRT device 202 may be integrated with one or more other devices or apparatuses, such as one or more of the client devices 204(1)-204(n). Moreover, one or more of the devices of the RTRRT device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the RTRRT device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the RTRRT device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the RTRRT device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured from eavesdropping, and these applications may be distributed among client devices 204(1)-204(n). The enterprise's distributed applications may include software that is based on microservices architecture, for example.

Although the network environment 200 with the RTRRT device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RTRRT device 202, the client devices 204(1)-204(n), the server devices 206(1)-206(n), and the databases 208(1)-208(n), for example, may be configured to operate as virtual instances on the same physical machine. In other words, one or more of the RTRRT device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

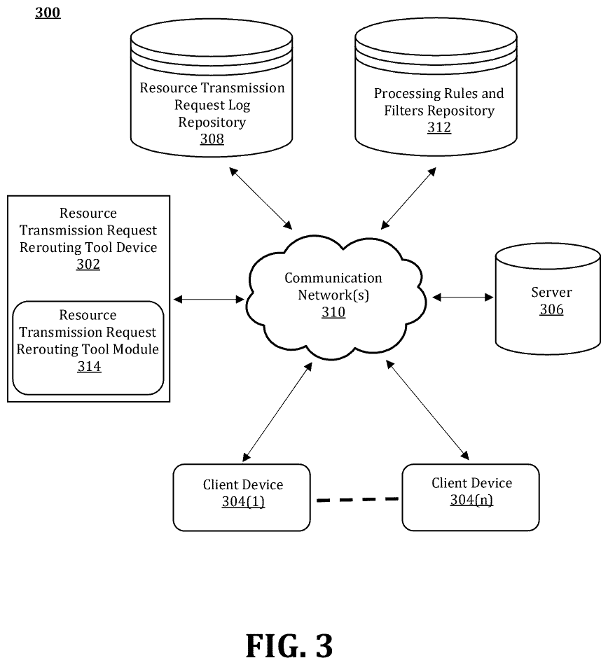

The RTRRT device 302 is described and illustrated in FIG. 3 as including resource transmission request rerouting tool module 314, although it may include other rules, policies, modules, databases, or applications, for example. As will be described below, resource transmission request rerouting tool module 314 is configured to implement an IaaS data center within an enterprise network. Resource transmission request rerouting tool module 314 may include software that is based on microservices architecture, for example.

Resource transmission request rerouting tool module 314 may be integrated with one or more devices or apparatuses, such as client devices 304(1)-304(n), where resource transmission request rerouting tool module 314 may be implemented as an application or as an addon or plugin to another application of the one or more devices or apparatuses, and where resource transmission request rerouting tool module 314 may execute in the background.

A configuration 300 for applying a resource transmission request rerouting tool to an aspect of the network environment of FIG. 2 is illustrated as being executed in FIG. 3. Specifically, a first client device 304(1) and a second client device 304(2) are illustrated as being in communication with RTRRT device 302. In this regard, the first client device 304(1) and the second client device 304(2) may be “clients” of the RTRRT device 302 and are described herein as such. Nevertheless, it is to be known and understood that the first client device 304(1) and/or the second client device 304(2) need not necessarily be “clients” of the RTRRT device 302, or any entity described in association therewith herein. Any additional or alternative relationship may exist between either or both of first client device 304(1), second client device 304(2) and RTRRT device 302.

Resource transmission request rerouting tool module 314 of RTRRT device 302 may communicate with resource transmission request log repository 308. RTRRT device 302 may utilize resource transmission request log repository 308 to maintain a log of every resource transmission request's outcome. In addition, resource transmission request rerouting tool module 314 of RTRRT device 302 may also communicate with processing rules and filters repository 312. RTRRT device 302 may utilize processing rules and filters repository 312 to store at least one from among: at least one set of processing rules and at least one set of processing filters.

In an embodiment, resource transmission request rerouting tool module 314 may be configured to provide a dynamically customizable interface for selecting, to communicate with, at least one server device at least one from among server devices 306(1)-306(n). Moreover, RTRRT device 302 may receive and transmit data via communication network(s) 210. RTRRT device 302 may receive and transmit data such as code that is written in one or more of the following dialects: transaction control language (TCL), data manipulation language (DML), data control language (DCL) and data definition language (DFL). Additionally, via communication network(s) 310, RTRRT device 302 may respectively receive and transmit data from and to one or more from among client devices 304(1)-304(n) and the server devices 306(1)-306(n).

However, FIG. 3 depicts the first client device 304(1) and the second client device 304(2) as belonging to communication network(s) 310, and RTRRT device 302 may communicate with any one or more devices or apparatuses that belong to the communication network(s) 310, such as one or more from among client devices 304(1)-304(n). For example, RTRRT device 302 may utilize a graphical user interface (GUI) to communicate with one or more from among client devices 304(1)-304(n), and communication network(s) 310 may comprise a cluster that belongs to the above-mentioned enterprise that may be secured from eavesdropping. In a further embodiment, communication network(s) 310 may comprise a cluster of distributed applications that belong to the enterprise.

The first client device 304(1) may be, for example, a smart phone. Of course, the first client device 304(1) may be any additional device described herein. The second client device 204(2) may be, for example, a personal computer (PC). Of course, the second client device 204(2) may also be any additional device described herein.

The client devices 204(1)-204(n) may represent, for example, computer systems of the enterprise's client network. The first client device 204(1) may represent, for example, one or more computer systems of a client or of a cluster of clients within the enterprise or client network. Of course, the first client device 204(1) may include one or more of any of the devices described herein. The second client device 204(2) may be, for example, one or more computer systems of another client or cluster of clients within the enterprise or client network. Of course, the second client device 204(2) may include one or more of any of the devices described herein.

The process may be executed via the communication network(s) 310, which may comprise plural networks as described above. For example, in an embodiment, either or both of the first client device 204(1) and the second client device 204(2) may communicate with the RTRRT device 302 via broadband or cellular communication. Of course, these embodiments are merely exemplary and are not limiting or exhaustive.

Resource transmission request rerouting tool module 314 may programmatically configure and communicate with server devices 306(1)-306(n), which may respectively correspond to remote clusters of server devices, such as a server farm, for example.

Resource transmission request rerouting tool module 314 may execute a process that programmatically configures and communicates with one or more server devices from among server devices 306(1)-306(n). In some embodiments, at least one from among server devices 306(1)-306(n) may comprise a processing platform.

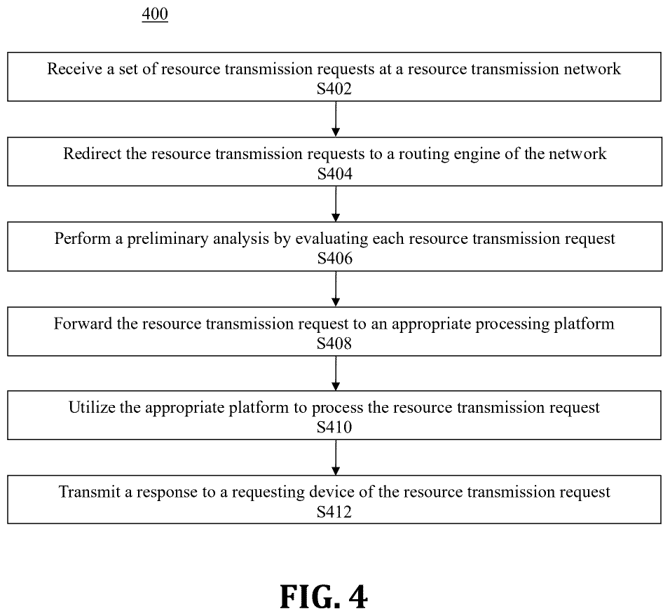

A process for a resource transmission request rerouting tool is generally indicated at flowchart 400 in FIG. 4.

In process 400, resource transmission request rerouting tool module 314 may be configured to intercept resource transmission requests that are associated with a resource transmission network of an enterprise. In process 400, resource transmission request rerouting tool module 314 may intercept the resource transmission requests in order to optimize and, thereby, improve the resource transmission network's processing efficiency by managing (e.g., prioritizing, rerouting, restricting, etc.) the distribution of such requests according to their respective characteristics and contexts.

At step S402, a resource transmission network (such as communication network(s) 310, for example) of an enterprise may be configured to receive at least a first resource transmission request. Hence, the resource transmission network may receive a first plurality of resource transmission requests. In other words, at step S402, the resource transmission network may be configured to receive a first set of resource transmission requests.

In some embodiments, the enterprise may comprise a private entity or network, such as a resource network, for example. Accordingly, the resource transmission network may be configured to provide services to clients. More particularly, the resource transmission network may be configured to provide resources to its clients via electronic transmissions.

Therefore, resource transmission network clients may utilize the enterprise's resource transmission network to request at least one of the enterprise's resources. In response, components of the resource transmission network may be configured to receive, process and respond to, various requests from its clients for at least one of the enterprise's resources.

Moreover, one or more components of the resource transmission network may be configured to electronically transmit one or more network resources to one or more resource transmission network clients. Additionally, the resource transmission network's resource requests (and replies to such requests) may utilize one or more standard electronic transmission (and/or communication) formats.

By way of example, the resource transmission network's standard electronic communication format(s) may conform to at least one standard (such as, an international standard), which may include one or more standards that are set by an international standard organization such as an international organization for standardization (the “ISO”), for example.

It should also be noted that each of the resource transmission network's standard electronic transmission/communication formats comprises at least one field. In embodiments, each network format may comprise at least one from among the following fields: a message length field, a message header field, message type field, at least a primary bitmap field, and a data elements field. In such embodiments, the at least the primary bitmap field may comprise at least one from among the following fields: the primary bitmap field, a secondary bitmap field, and a tertiary bitmap field.

At step S404, the resource transmission network may be configured to redirect each request from among the first set of resource transmission requests away from a default processing platform, which may be an external processing platform and/or a legacy processing platform of the enterprise's resource transmission network, for example. More particularly, at step S404, the resource transmission network may redirect each request from among the first set of resource transmission requests toward a resource transmission request rerouting engine, namely resource transmission request rerouting tool module 314.

In some embodiments, after step S404, the resource transmission network may be configured to store, or to have resource transmission request rerouting tool module 314 store, the first set of resource transmission requests within a resource transmission request log (such as resource transmission request repository log 308, for example).

At step S406, resource transmission request rerouting tool module 314 may be configured to perform a preliminary analysis of each request from among the first set of resource transmission requests. More particularly, at step S406, resource transmission request rerouting tool module 314 may be configured to perform preliminary analyses by evaluating each resource transmission request according to (or against) at least one from among a first set of rules and a first set of filters.

For example, during step S406, resource transmission request rerouting tool module 314 may be configured to retrieve the at least one from among the first set of rules and the first set of filters from at least one network repository, such as processing rules and filters repository 312, for example. Such retrieval may be based on at least one field of the set of resource transmission requests. More particularly, resource transmission request rerouting tool module 314 may be configured to utilize the at least one field to perform this retrieval by searching the at least one network repository for pertinent rules and filters, such as the at least one from among the first set of rules and the first set of filters.

In some embodiments, resource transmission request rerouting tool module 314 may be configured to perform various traffic management functions including, but not limited to, load balancing, traffic migration, traffic blocking, and traffic volume restriction, for example.

In further embodiments, the system described herein may utilize one or more of these traffic management functions for security reasons or to maintain the integrity of its resource transmission request network's resources. For example, a feature such as traffic blocking may be utilized to protect network resources against a denial-of-service attack, such as a distributed denial-of-service (DDoS) attack. Similarly, the system may protect network resources (from being overloaded) by utilizing traffic volume restriction functionalities to limit the volume of the resource transmission network's traffic.

In process 400, resource transmission request rerouting tool module 314 may be configured to perform the preliminary analysis of step S406 by evaluating at least one field of the first set of resource transmission requests. As mentioned in further detail above, fields of each of these requests may conform to one or more standard electronic transmission (and/or communication) formats.

Additionally, in step S406, the preliminary analysis performed by resource transmission request rerouting tool module 314 may be configured to include further operations, such as a determination of whether the first set of resource transmission requests includes any patterns (e.g., an anomalous or suspicious traffic pattern).

At step S406, resource transmission request rerouting tool module 314 may utilize an artificial intelligence and machine learning (AI/ML) model to determine whether the first (or any subsequently received) set of resource transmission requests includes a pattern. In such embodiments, the AI/ML model may utilize one or more historical resource transmission requests (e.g., one or more historical sets of resource transmission requests) as training data for determining whether the first or a subsequent (e.g., second, third, fourth, etc.) set of resource transmission requests includes any patterns.

Accordingly, the system may utilize a repository (such as resource transmission request repository log 308) to store one or more historical resource transmission requests logs, which may be utilized by resource transmission request rerouting tool module 314 during one or more preliminary analyses of step S406.

During step S406, resource transmission request rerouting tool module 314 may be configured to perform at least one preliminary analysis by evaluating at least one resource transmission request, respectively.

In some embodiments, at step S406, the at least one preliminary analysis may comprise a determination of at least one type of at least one resource transmission request. Additionally, the at least one preliminary analysis may also (or alternatively) comprise a determination of at least one source of the at least one resource transmission request.

During step S406, resource transmission request rerouting tool module 314 may be configured to evaluate the first set of resource transmission requests against at least one from among a first set of rules and a first set of filters, and the at least one from among the first set of rules and the first set of filters may comprise at least one from among a processing platform threshold resource transmission amount and a processing platform threshold response time.

In some embodiments, the processing platform threshold resource transmission amount may limit the requested resource's amount or the number of resource processing requests that may be assigned to at least one processing platform of the resource transmission network. Similarly, the processing platform threshold response time may limit the total amount of time that it takes for the resource transmission network to process at least one particular type of request.

Accordingly, resource transmission request rerouting tool module 314 may be configured to evaluate the first set of resource transmission requests to determine whether any processing platform threshold response times have expired and, if so, resource transmission request rerouting tool module 314 may be further configured to transmit any corresponding resource transmission requests to a predetermined processing platform in response to such determination(s) that a processing platform threshold response time has expired.

The predetermined processing platform(s) may comprise at least one from among an internal processing platform (such as the legacy processing platform) and an external processing platform (such as a commercial resource transmission request processing platform that belongs to an external vendor).

After step S406, resource transmission request rerouting tool module 314 may be configured to utilize step S406's preliminary analysis to determine whether at least one processing platform that is available to the resource transmission network, corresponds to any processing required for at least one request from among the first set of resource transmission requests. Such corresponding processing platform(s) may be implemented within at least one server device 206 from among server devices 206(1)-206(n) (or server device 306 from among server devices 306(1)-306(n), for example).

Accordingly, corresponding processing platform(s) may comprise at least one from among the following processing platforms: a new processing platform of the resource transmission network, an internal and/or external heightened-scrutiny processing platform, a dummy processing platform, the legacy processing platform, and the commercial resource transmission request processing platform from an external vendor.

At step S408, resource transmission request rerouting tool module 314 may be configured to forward the resource transmission request to at least one of the corresponding processing platforms. In addition, during step S408, resource transmission request rerouting tool module 314 may also be configured to prioritize the first set of resource transmission requests according to at least one from among: a quality of assurance (“QoA”) that is associated with a request, an importance of the request, a sensitivity of the request, a confidentiality of the request, and an authenticity of the request, for example.

Similarly, to prioritize the set of resource transmission requests, during step S408, resource transmission request rerouting tool module 314 may also be configured to re-prioritize an existing priority scheme, which may be an explicit and/or implied scheme (such as “first in, first out” (FIFO), for example). To prioritize the set of resource transmission requests, resource transmission request rerouting tool module 314 may be configured to re-prioritize at least one from among: the set of resource transmission requests; and at least one additional resource transmission request awaiting processing.

After each resource transmission request is forwarded to (and possibly given its own unique priority for) at least one of its corresponding processing platforms, then process 400 may proceed to step S410 for that particular resource transmission request or set of resource transmission requests. At step S410, the respectively corresponding processing platform(s) may be configured to process each resource transmission request (or the set of resource transmission requests) that is forwarded to it/them (i.e., the corresponding processing platform(s)) for processing, respectively. Accordingly, at step S412, the respectively corresponding processing platform(s) may be configured to respond to each resource transmission request (or the set of resource transmission requests) that the respectively corresponding processing platform(s) process(es).

The response performed at step S412 may comprise: generating at least one reply to the resource transmission request (or the set of such requests); and transmitting the at least one reply to at least one device that was utilized to transmit the resource transmission request that was received by the resource transmission network at step S402.

Accordingly, an enterprise's resource transmission network may utilize process 400 to optimize and, thereby, improve the resource transmission network's processing efficiency by managing (e.g., prioritizing, rerouting, restricting, etc.) the distribution of such requests according to their respective characteristics and contexts.

For example, the at least one reply may comprise at least one from among: an authorization of the resource transmission request; and a denial of the resource transmission request. The resource transmission request authorization may comprise a resource (or details for accessing a resource) that was requested by the resource transmission request.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for implementing an international standard-based resource transmission request rerouting tool, the method comprising:
receiving, at a resource transmission network of an enterprise, a first set of resource transmission requests that are associated with the resource transmission network;
redirecting, away from a legacy processing platform of the resource transmission network, the first set of resource transmission requests to a resource transmission request routing engine;
performing, by the resource transmission request routing engine, a preliminary analysis by evaluating each resource transmission request against at least one from among a first set of rules and a first set of filters;
based on the preliminary analysis, forwarding, by the resource transmission request routing engine, the resource transmission request to a corresponding processing platform that is configured to process the resource transmission request; and
processing, by the corresponding processing platform, the resource transmission request.

2. The method of claim 1, wherein the corresponding processing platform comprises at least one from among a new processing platform of the resource transmission network, a heightened-scrutiny processing platform, a dummy processing platform, the legacy processing platform, and a commercial resource transmission request processing platform from an external vendor.

3. The method of claim 1, wherein the at least one from among the first set of rules and the first set of filters: evaluates a first set of fields of the resource transmission request, wherein the resource transmission request comprises a standard resource transmission request format that includes the first set of fields.

4. The method of claim 3, wherein the first set of fields comprises at least one from among a message length field, a message header field, message type field, at least a primary bitmap field, and a data elements field, and wherein the at least the primary bitmap field comprises at least one from among the primary bitmap field, a secondary bitmap field, and a tertiary bitmap field.

5. The method of claim 1, wherein the preliminary analysis comprises determining whether the first set of resource transmission requests includes at least one from among an anomalous traffic pattern and a suspicious traffic pattern.

6. The method of claim 1, wherein the preliminary analysis comprises determining at least one from among a resource transmission request type and a resource transmission request source.

7. The method of claim 1, wherein the at least one from among the first set of rules and the first set of filters comprises: at least one from among a load balancing rule, a load balancing filter, a traffic migration rule, a traffic migration filter, a traffic blocking rule, a traffic blocking filter, a traffic volume rule, and a traffic volume filter, wherein at least one from among the traffic blocking rule and the traffic blocking filter comprises at least one from among a denial-of-service attack blocking rule and a denial-of-service attack blocking filter, and wherein at least one from among the traffic volume rule and the traffic volume filter comprises at least one from among a traffic volume limiting rule and a traffic volume limiting filter.

8. The method of claim 1, wherein the at least one from among the first set of rules and the first set of filters comprises: at least one from among a processing platform threshold resource transmission amount and a processing platform threshold response time.

9. The method of claim 1, wherein the processing comprises:
generating, by the corresponding processing platform, a reply to the resource transmission request; and
transmitting, via the resource transmission network, the reply to a requesting device of the resource transmission request.

10. The method of claim 9, wherein the reply comprises at least one from among an authorization of the resource transmission request and a denial of the resource transmission request.

11. A system for implementing an international standard-based resource transmission request rerouting tool, the system including:
a processor; and
memory storing instructions that, when executed by the processor, causes the processor to perform operations comprising:
receiving, at a resource transmission network of an enterprise, a first set of resource transmission requests that are associated with the resource transmission network;
redirecting, away from a legacy processing platform of the resource transmission network, the first set of resource transmission requests to a resource transmission request routing engine;
performing, by the resource transmission request routing engine, a preliminary analysis by evaluating each resource transmission request against at least one from among a first set of rules and a first set of filters;
based on the preliminary analysis, forwarding, by the resource transmission request routing engine, the resource transmission request to a corresponding processing platform that is configured to process the resource transmission request; and
processing, by the corresponding processing platform, the resource transmission request.

12. The system of claim 11, wherein when the instructions are executed by the processor, the at least one from among the first set of rules and the first set of filters: evaluates a first set of fields of the resource transmission request, wherein the resource transmission request comprises a standard resource transmission request format that includes the first set of fields.

13. The system of claim 12, wherein when the instructions are executed by the processor, the first set of fields comprises at least one from among a message length field, a message header field, message type field, at least a primary bitmap field, and a data elements field, wherein the at least the primary bitmap field comprises at least one from among the primary bitmap field, a secondary bitmap field, and a tertiary bitmap field.

14. The system of claim 11, wherein when the instructions are executed by the processor, the preliminary analysis comprises determining whether the first set of resource transmission requests includes at least one from among an anomalous traffic pattern and a suspicious traffic pattern.

15. The system of claim 11, wherein when the instructions are executed by the processor, the at least one from among the first set of rules and the first set of filters comprises: at least one from among a load balancing rule, a load balancing filter, a traffic migration rule, a traffic migration filter, a traffic blocking rule, a traffic blocking filter, a traffic volume rule, and a traffic volume filter, wherein at least one from among the traffic blocking rule and the traffic blocking filter comprises at least one from among a denial-of-service attack blocking rule and a denial-of-service attack blocking filter, and wherein at least one from among the traffic volume rule and the traffic volume filter comprises at least one from among a traffic volume limiting rule and a traffic volume limiting filter.

16. The system of claim 11, wherein when the instructions are executed by the processor, the at least one from among the first set of rules and the first set of filters comprises: at least one from among a processing platform threshold resource transmission amount and a processing platform threshold response time.

17. A non-transitory computer-readable medium for implementing an international standard-based resource transmission request rerouting tool, the computer-readable medium storing instructions that, when executed by a processor, causes the processor to perform operations comprising:
receiving, at a resource transmission network of an enterprise, a first set of resource transmission requests that are associated with the resource transmission network;
redirecting, away from a legacy processing platform of the resource transmission network, the first set of resource transmission requests to a resource transmission request routing engine;
performing, by the resource transmission request routing engine, a preliminary analysis by evaluating each resource transmission request against at least one from among a first set of rules and a first set of filters;
based on the preliminary analysis, forwarding, by the resource transmission request routing engine, the resource transmission request to a corresponding processing platform that is configured to process the resource transmission request; and
processing, by the corresponding processing platform, the resource transmission request.

18. The computer-readable medium of claim 17, wherein when the instructions are executed by the processor, the corresponding processing platform comprises at least one from among a new processing platform of the resource transmission network, a heightened-scrutiny processing platform, a dummy processing platform, the legacy processing platform, and a commercial resource transmission request processing platform from an external vendor.

19. The computer-readable medium of claim 17, wherein when the instructions are executed by the processor, the preliminary analysis comprises determining at least one from among a resource transmission request type and a resource transmission request source.

20. The computer-readable medium of claim 17, wherein when the instructions are executed by the processor, the processing comprises:
generating, by the corresponding processing platform, a reply to the resource transmission request; and
transmitting, via the resource transmission network, the reply to a requesting device of the resource transmission request.
